(19) United States
(12) Patent Application Publication
(10) Pub. No.: US 2017/0175443 A1
(43) Pub. Date: Jun. 22, 2017

(54) LADDER BRACE

(71) Applicant: SSS Steel Profiles Limited, Cardiff (GB)

(72) Inventor: Steven PESTICCIO, Cardiff (GB)

(21) Appl. No.: 15/118,318

(22) PCT Filed: Feb. 9, 2015
(86) PCT No.: PCT/GB2015/050349

§ 371 Date: Aug. 11, 2016

(30) Foreign Application Priority Data
Feb. 11, 2014 (GB) 1402291.7

(51) Int. Cl. E06C 7/42; E06C 7/46; E06C 7/44

(52) U.S. Cl. CPC E06C 7/423; E06C 7/426; E06C 7/44; E06C 7/46

(57) ABSTRACT

The present invention concerns a ladder brace. More particularly, but not exclusively, this invention concerns a ladder brace for engaging with the legs of a ladder thereby providing stability to the ladder. A ladder brace comprises a receiving portion for receiving and engaging with the stiles of a ladder, and at least one support member extending away from the receiving portion. The receiving portion comprises an aperture with a first inner edge and second inner edge, wherein the first inner edge is disposed away from and opposite to the second inner edge, such that when a ladder is placed within the receiving portion each ladder stile engages with the first inner edge and second inner edge.

### FIELD OF THE INVENTION

The present invention concerns a ladder brace. More particularly, but not exclusively, this invention concerns a ladder brace for engaging with the legs of a ladder thereby providing stability to the ladder.

### BACKGROUND OF THE INVENTION

In operation ladders can be unstable for many reasons, for example: by being positioned incorrectly, being overloaded, being used without care and/or being positioned on slippery or uneven surfaces. Ladder instability, especially when an individual is climbing or working from a ladder, can lead to the ladder falling. This is known to be a cause of accidents at home and in the workplace. These accidents have been known to lead to serious injury.

When an unstable ladder is leaned against a surface it can fall in several ways. The bottom portion of the ladder may slide away from the surface on which the ladder is leaning. This may be due to: insufficient friction between the feet of the ladder and the surfaces on which the feet of the ladder rests, or the ladder feet resting on a loose surface. Alternatively, the ladder may topple sideways. This may be due to a user of the ladder shifting their weight, or their equipment, too far outside the ladder's stiles. A ladder can also fall due to a combination of these two scenarios. Furthermore, it is possible for a ladder to topple away from the surface on which the ladder is leaning if the ladder is placed too close to vertical.

Currently there are a number of devices and methods designed to improve the stability of ladders. These stabilizers work in various ways, for example International Patent Application Publication Number WO2004/092525 discloses an outrigger style stabilizer wherein telescopic outriggers are mounted to each side of a ladder. The outriggers slope downwardly from a point of attachment to each ladder stile and have an end which engages with the ground or other supporting surface. In another example US patent application publication number US2012/0234628 discloses a ladder stabilizer which engages with a lower ladder rung via a ladder rung engagement rod. The device then provides a means to anchor the device to the ground.

Often these ladder braces and stabilisers can have significant cost, and be inconvenient or complex to set up and use. The present invention seeks to mitigate the above-mentioned problems. Alternatively or additionally, the present invention seeks to provide a convenient and simple ladder brace to reduce the risk of a ladder falling.

### SUMMARY OF THE INVENTION

According to a first aspect of the invention there is provided a ladder brace comprising a receiving portion for receiving and engaging with the stiles of a ladder, and at least one support member extending away from the receiving portion; wherein the receiving portion comprises an aperture with a first inner edge and second inner edge, wherein the first inner edge is disposed away from and opposite to the second inner edge, such that when a ladder is placed within the receiving portion each ladder stile engages with the first inner edge and second inner edge.

Whilst we refer herein to the vertical members of a ladder as being stiles, the skilled person will appreciate these may also been known as stringers or rails, and our use of the term stiles encompasses these different terms.

When the bottom portion of a ladder is inserted into the receiving portion, and the ladder is inclined for use, the first inner edge and second inner edge of the receiving portion engage with the stiles of the bottom portion of a ladder. The support member contacts the ground and causes a wedging action between the first and second inner edges with the stiles of the ladder. The friction and mechanical engagement between the receiving portion and the stiles prevents the ladder from sliding through the receiving portion. The ladder brace may thereby provide support to the ladder.

By engaging such a ladder brace with a ladder, the stability of the ladder may be improved. For instance, the ladder may be prevented from slipping away from the wall because the support member provides an additional engagement point between the ladder and the ground. Furthermore, the ladder brace can be easily and conveniently put to use without the need for extensive installation and adjustment. The ladder brace does not require any moving parts so may also be simple to manufacture and produce.

The first inner edge and second inner edge for engaging a ladder may be connected to form at least one slot. The slot may be configured to receive the bottom portion of a ladder. A slot type ladder brace may be shaped to receive ladders of various dimensions. The first and/or second inner edge may include friction increasing surfaces, such as dimples or grooves. Alternatively or additionally, a friction increasing material may be provided at the first and/or second inner edge, for example a non-slip rubber material.

The ladder brace may be constructed from a single piece of material. The material may be metal. The manufacture may involve bending and cutting a single piece of metal. Such a construction would make the ladder brace relatively simple to produce. In an alternative arrangement, the ladder brace may be cast. Alternative materials may be used, for example, the ladder brace may be moulded of a suitably strong plastics material, or formed of carbon-fibre reinforced plastic. In a yet further alternative, the ladder brace may comprise distinct metal sections welded together to produce the receiving section and support section.

The ladder brace may comprise two support members. When engaged with a ladder, each support member may provide extra friction between the ladder and the ground, reducing the probability of slippage. Additional points of contact between the ladder and the ground will also increase the stability of the ladder. The at least one support member may comprise feet or surfaces configured to provide improved frictional contact with the ground. Such features may include rubber feet or stippled or knurled sections on the support member. Where two support members are provided, the support members may be joined by a cross-brace to make the ladder brace more rigid. When engaged with a ladder, the two support members may be the only point of contact between the ladder brace and the ground. The ladder brace may stabilise a ladder without requiring any further points of contact with the ground or any other surface, for example a wall. When only a single support member is provided, the ladder brace may contact the ground at a single point in order to stabilise a ladder.

The ladder brace may comprise at least one stiffening member, the stiffening member extending from the receiving portion to the at least one support member. The stiffening member may increase the stiffness of the connection between the receiving portion and the at least one support member. An example stiffening member is a cross-strut. The stiffening member may be welded to the receiving portion and the support member.

The ladder brace may comprise two support members which diverge from each other. The diverging support members may splay outwards beyond the stiles of a ladder engaged with the ladder brace. Splayed support members may prevent sideways toppling of the ladder by reducing the probability that the centre of gravity of the ladder system will extend beyond the outermost support. A stiffening member may be associated with each support member. For example, a metal cross-strut may be welded between each support member and the receiving portion.

The inner edges with which the ladder stiles engage may define a width of the aperture of the receiving section. The separation of the ends of the support members may be greater than the width of the receiving section. Such support members will extend beyond the stiles of any ladder capable of being accommodated within the receiving section.

The support member may comprise an anchor point. The anchor point may allow the ladder brace to be anchored to the ground or nearby object. The support member may comprise feet which are configured to receive a peg or ground spike. The support member may be able to receive guy ropes. Anchoring of the support member will further reduce the chance of slippage or toppling of a ladder engaged with the ladder brace.

The first inner edge and second inner edge of the receiving portion may define a plane. The support member may extend at an angle to the plane defined by the first inner edge and second inner edge. The support member may extend at an angle of less than 90 degrees to the plane defined by the first inner edge and second inner edge. The angle, and distance between the first inner edge and second inner edge of the receiving portion, may be selected to provide stability to a particular range of ladder sizes. As an example, if the ladder is inclined at an angle of 1 in 4 or more, an advantageous angle of between the support, member and the plane defined by the first inner edge and second inner edge is 65 degrees.

At least one secondary support member may extend from the receiving portion. The secondary support member may be mounted away from and opposite to the primary support member. The secondary support structure may be positioned above and not in contact with the ground when the ladder brace is engaged with a ladder.

According to a second aspect of the invention, there is provided a method of stabilising a ladder comprising the steps of: providing a ladder brace according to the first aspect of the invention, inserting the stiles of the bottom portion of a ladder into the receiving section of the ladder brace, and positioning the ladder in place such that the at least one support structure is in contact with the ground and the stiles of the ladder are engaged with the first and second inner edges of the receiving section.

The skilled person will appreciate that where the term “the ground” is used, it means any surface on which the bottom of a ladder is placed in contact in order to provide the usual functions of a ladder. For example, if the bottom of a ladder is placed in contact with wooden support boards of a, scaffolding arrangement, the contact with the wooden support boards falls within the scope of the term “the ground”, even though the support boards are suspended above ground level.

According to a third aspect of the invention, there is provided a ladder system, comprising a ladder, the ladder comprising a first and second stile, and a ladder brace, the ladder brace comprising a ladder receiving slot for receiving and engaging with the stiles of the ladder, and at least one support structure, the support structure extending away from the ladder receiving slot.

The ladder receiving slot may comprise a first inner edge and a second inner edge, wherein the stiles of the ladder engage with both the first inner edge and second inner edge when the ladder is engaged with the ladder brace.

It will of course be appreciated that features described in relation to one aspect of the present invention may be incorporated into other aspects of the present invention. For example, the method of the invention may incorporate any of the features described with reference to the apparatus of the invention and vice versa. Alternatively or additionally, any of the first, second, or third aspects of the invention may include any of the features described with reference to other aspects of the invention.

### DESCRIPTION OF THE DRAWINGS

Embodiments of the present invention will now be described by way of example only with reference to the accompanying schematic drawings of which:

FIG. 1 shows a side view of a ladder brace, according to a first embodiment of the invention, engaged with a ladder;

FIG. 1a shows a schematic view of the first embodiment of the invention engaged with a ladder;

FIG. 2 shows a side view of a ladder brace, according to a second embodiment of the invention, engaged with a ladder;

FIG. 2a shows a plan view of the second embodiment of the invention;

FIG. 3 shows a plan view of a ladder brace according to a third embodiment of the invention;

FIG. 4 shows a side view of a ladder brace, according to a fourth embodiment of the invention, engaged with a ladder and with a support member anchored to the ground; and

FIG. 5 shows a side view of a ladder brace according to a fifth embodiment of the invention.

### DETAILED DESCRIPTION

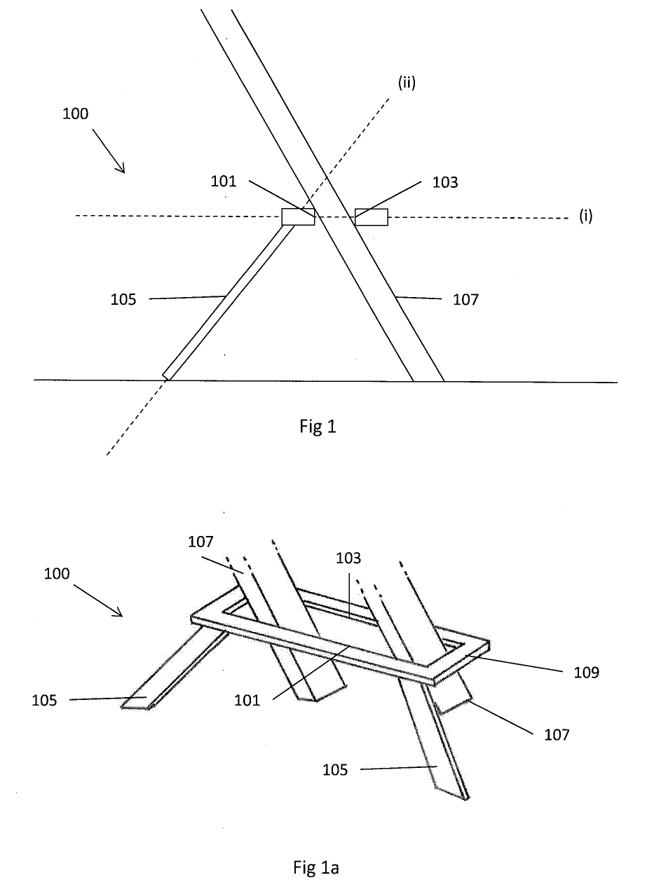

FIGS. 1 and la show a first embodiment of the invention comprising a ladder brace 100 with a ladder receiving portion comprising an aperture including a first inner edge 101, a second inner edge 103, and two splayed support members 105. The ladder brace is shown engaged with a ladder 107, the ladder being inclined for use and resting on the ground.

The first inner edge 101 and second inner edge 103 are disposed away from and opposite each other and define an aperture within the receiving portion. The receiving portion receives the stiles of a ladder 107 between the first inner edge 101 and second inner edge 103. When a ladder is received within the receiving portion, the ladder stiles will have an upward facing face and a downward facing face. The upward facing face is engaged with the second inner edge 103 and the downward facing face is engaged with the first inner edge 101.

In this first embodiment of the invention 100, as shown in FIG. 1a, the members that provide the first inner edge 101 and second inner edge 103 are joined at either end 109 to form a rectangular slot shaped receiving portion.

As shown in FIG. 1, the plane defined by the first inner edge 101 and second inner edge 103, indicated by the numeral (i), is approximately parallel to the ground. The exact orientation of this plane will depend on the thickness of the ladder stiles 107 relative to the distance between the first surface 101 and second surface 103.

The two splayed support members 105 extend from the receiving portion in a plane (ii) at an angle to the plane (i) towards and into contact with the ground. The support members 105 are also configured to extend outwards and away from each other, wherein the separation of the ends of each support member is greater than the width of the receiving section.

When a ladder engages with a ladder brace according to the first embodiment of the invention, the ladder's stiles 107 will engage with and exert a force on the first inner edge 101 and the second inner edge 103 of the receiving portion. The support member 105 engaging with the ground will cause a wedging action between the first inner edge 101 and second inner edge 103 with the ladder's stiles 107. The friction and mechanical engagement between the inner edges and the stiles prevents the ladder from sliding through the receiving portion. The ladder brace 100 will thereby provide support to the ladder. The configuration of the support members 105, may provide lateral stability to the ladder system, an increased number of points of contact between the ladder and the ground, and increased friction between the ladder and the ground.

The ladder brace 100 does not require any moving parts and so can be produced from a single piece of material. In the first embodiment, the ladder brace 100 is formed from a steel plate which is cut and then bent into the required configuration. In alternative embodiments the ladder brace may comprise a cast piece of metal, one or more pieces of metal welded into the required configuration or a plastics material, for example carbon fibre reinforced plastic shaped into the required configuration. It is advantageous for the manufacturing of the ladder brace 100 to be as simple and as straightforward as possible in order to keep production costs to a minimum.

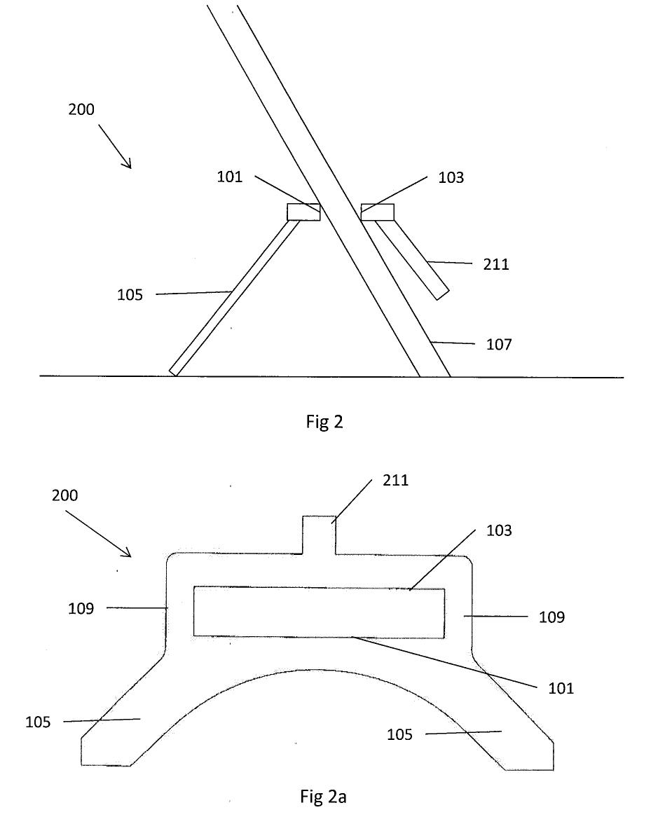

FIGS. 2 and 2a show a side view and plan view respectively of a second embodiment of the ladder brace 200. The second embodiment shares a similar form to the first embodiment; however the second embodiment features a secondary support member 211. Where structural features are shared between the first and second embodiment, the same reference numerals are used for the sake of clarity. The secondary support member is mounted to the opposite side of receiving portion to the first and second support members 103. In FIGS. 2 and 2a the ladder brace is engaged with a ladder stile 107. The secondary support member 211 extends towards the ground in approximately the direction of the ladder's stiles 107. In this embodiment the secondary support member 211 does not extend fully to the surface on which the ladder is resting. The secondary support may help prevent the ladder brace sliding down the ladder and dropping to the floor, thus no longer providing support to the ladder.

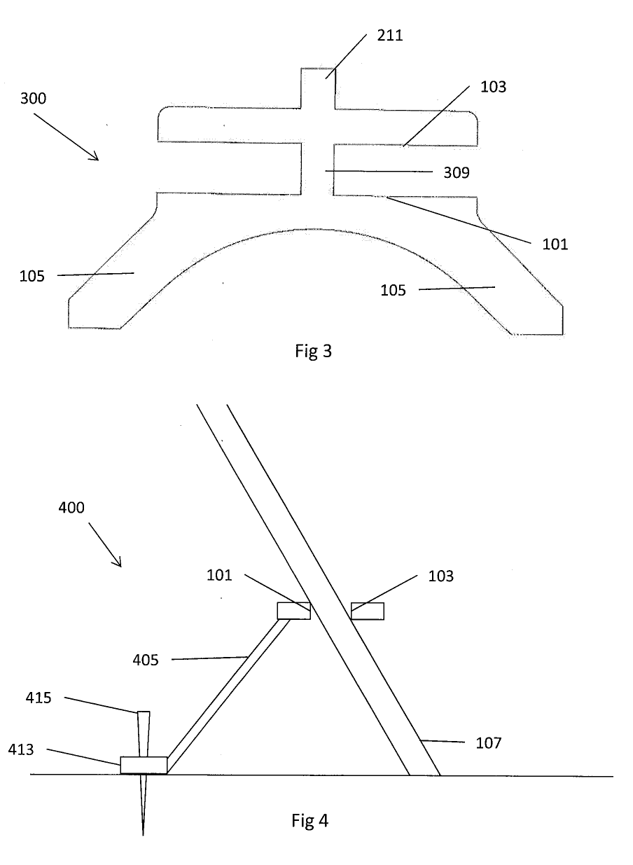

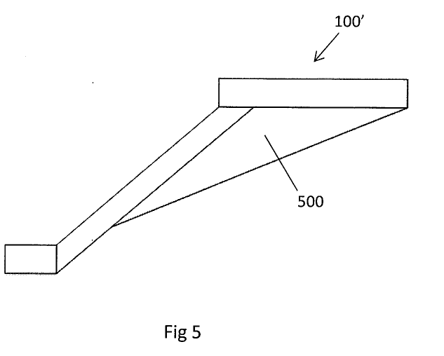

FIG. 3 shows a plan view of a third embodiment of the ladder brace 300. The third embodiment shares a similar form to the second embodiment; however in this embodiment, the members that provide the first inner edge 101 and second inner edge 103 are joined in the middle 309 to form a double-slot shaped receiving portion. As in the first embodiment two splayed support members 105 are mounted to the receiving portion. FIG. 4 shows a side view of a fourth embodiment of a ladder brace 400. The fourth embodiment is similar in form to the first embodiment; however the fourth embodiment comprises a support member 405 that features an anchor point by which the support member 405 can be anchored to the ground. In this particular embodiment the bottom of the support member comprises a foot 413 including an opening which can receive a peg or ground spike 415. The ground spike may be driven into the ground to anchor the ladder brace 400.

FIG. 5 shows a fifth embodiment of the invention, wherein a ladder brace 100′, substantially as described with reference to FIG. 1 and the first embodiment of the invention is provided. However, there is an additional cross-strut 500 provided between the support members and the receiving portion of the ladder brace 100′. The cross-strut increases the stiffness and strength of the ladder brace 100′.

Whilst the present invention has been described and illustrated with reference to particular embodiments, it will be appreciated by those of ordinary skill in the art that the invention lends itself to many different variations not specifically illustrated herein. In a yet alternative embodiment a ladder brace according to the first embodiment of the invention may be modified by the addition of a central supporting member in the approximate middle of the large receiving slot. The support members of the ladder brace may include a cross-strut from one support member to another support member. The cross-strut may increase the structural rigidity of the ladder brace.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A ladder brace comprising:
a receiving portion for receiving and engaging with the stiles of a ladder, and
at least one support member extending away from the receiving portion;
wherein the receiving portion comprises an aperture with a first inner edge and second inner edge,
wherein the first inner edge is disposed away from and opposite to the second inner edge, such that when a ladder is placed within the receiving portion each ladder stile engages with the first inner edge and second inner edge.

2. A ladder brace according to claim 1, wherein the first inner edge and second inner edge for engaging a ladder are connected to form a slot.

3. A ladder brace according to claim 1, wherein the ladder brace comprises a single piece of material.

4. A ladder brace according to claim 1, comprising two support members.

5. A ladder brace according to claim 4, wherein the support members diverge from each other.

6. A ladder brace according to claim 4, wherein the separation between each end of the support members is greater than the width of the receiving section.

7. A ladder brace according to claim 1, wherein the at least one support member comprises an anchor point.

8. A ladder brace according to claim 1, wherein the first inner edge and second inner edge define a plane, and the at least one support member extends at an angle to the plane defined by the first inner edge and second inner edge.

9. A ladder brace according to claim 8, wherein the at least one support member extends at an angle of less than 90 degrees to the plane defined by the first inner edge and second inner edge.

10. A ladder brace according to claim 1, wherein at least one secondary support member extends from the receiving portion, wherein the secondary support member is mounted away from and opposite to the at least one support member.

11. A ladder brace according to claim 10, wherein the at least one secondary support member does not extend to the ground when a ladder is engaged with the receiving section.

12. A method of stabilising a ladder comprising the steps of:
providing a ladder brace according to the first aspect of the invention,
inserting the stiles of the bottom portion of a ladder into the receiving section of the ladder brace, and
positioning the ladder in place such that the at least one support structure is in contact with the ground and the stiles of the ladder are engaged with the first and second inner edges of the receiving section.

13. A ladder system, comprising
a ladder, the ladder comprising a first and second stile, and
a ladder brace, the ladder brace comprising
a ladder receiving slot for receiving and engaging with the stiles of the ladder, and
at least one support structure, the support structure extending away from the ladder receiving slot.

14. (canceled)

15. (canceled)
